(19) United States
(12) Patent Application Publication
(10) Pub. No.: US 2026/0323127 A1
(43) Pub. Date: Oct. 15, 2026

(54) TECHNIQUES FOR IMPLEMENTING A GROUP USER PROFILE IN A MULTIMEDIA SYSTEM

(71) Applicant: Roku, Inc., San Jose, CA (US)

(72) Inventors: Philip Johnson Golyshko, Westminster, CO (US); Preston G. Smalley, Danville, CA (US); Lei Yu, Cupertino, CA (US); Margret Schmidt, Redwood City, CA (US)

(73) Assignee: Roku, Inc., San Jose, CA (US)

(21) Appl. No.: 19/176,330

(22) Filed: Apr. 11, 2025

(51) Int. Cl. H04N 21/475; G06F 16/735; H04N 21/258; H04N 21/431

(52) U.S. Cl. CPC H04N 21/4751; H04N 21/25891; H04N 21/431

(57) ABSTRACT

A computer-implemented method is described and includes automatically creating a group profile for an account associated with a streaming service platform, wherein the group profile is informed by a plurality of individual user profiles associated with the account, wherein each of the individual user profiles is associated with a different one of a plurality of users; presenting via a user interface (UI) of the streaming service platform representations of each of the group profile and the individual user profiles; prompting one of the users to select one of the profiles to use to view content items via the streaming service platform; and, subsequent to selection by the user of the group profile, presenting via the UI a collection of content item recommendations, wherein the content item recommendations are informed by contents of the individual user profiles collectively.

### TECHNICAL FIELD

This disclosure relates to multimedia systems, and more specifically, to techniques for implementing a group user profile in such systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A illustrates a block diagram of an example multimedia system, according to some embodiments of the disclosure.

FIG. 1B illustrates a content item retrieval system such as may be implemented in the multimedia system of FIG. 1A, according to some embodiments of the disclosure. B1 FIG. 2 illustrates a block diagram of an example media device, according to some embodiments of the disclosure.

FIG. 3 is a flowchart illustrating example operations that may be performed in a multimedia system to create a group profile, according to some embodiments of the disclosure.

FIGS. 4A-4B illustrate example screens that may be displayed during the example operations shown in FIG. 3, according to some embodiments of the disclosure.

FIG. 5 is a flowchart illustrating example operations that may be performed in a multimedia system to create a group profile, according to some alternative embodiments of the disclosure.

FIGS. 6A-6D illustrate example screens that may be displayed during the example operations shown in FIG. 5, according to some embodiments of the disclosure.

FIG. 7 is a flowchart illustrating example operations that may be performed in a multimedia system to create a group profile, according to other alternative embodiments of the disclosure.

FIGS. 8A-8E illustrate example screens that may be displayed during the example operations shown in FIG. 5, according to some embodiments of the disclosure.

FIG. 9 is a flowchart illustrating example operations that may be performed in a multimedia system when a group profile is selected, according to some embodiments of the disclosure.

FIG. 10 is a block diagram of an example computing device, according to some embodiments of the disclosure.

### DETAILED DESCRIPTION

### Overview

A user profile is a collection of data and settings associated with a user within a system, such as a streaming platform, and may include information that is used to identify the user, such as the user's name, age, and individual characteristics and/or preferences. User profiles associated with users of multimedia systems, such as media streaming platforms, may include such information about the user as the user's language preference, maturity level (e.g., “child” vs. “adult” and anywhere in between), specific viewing restrictions, viewing activity log, appearance of subtitles, playback settings, and personalized TV show and movie suggestions, as well as a list of TV shows and movies designated by the user as “favorites.” A user's profile may also maintain a watch history for the user comprising a record of the TV shows and movies (collectively “media content”) the user has watched and/or is currently watching, which may aid the platform in understanding the user's viewing preferences. The user's profile, including watch history, may be used to personalize the user's experience and media content recommendations, as well as to restrict the user's access to a particular class or classes of media content (e.g., based on the user's age and/or other profile settings).

A streaming service provider may support multiple profiles under a single account associated with a multimedia system. As a result, profiles may enable multiple people living within a single household in which a multimedia system is installed to enjoy a personalized viewing experience by creating his or her own profile. In this manner, profiles allow users individually to keep track of his or her own favorite TV shows and/or movies. Additionally, the multimedia system may provide recommendations to each user individually based on the contents of their profile, including the user's ratings (e.g., likes/dislikes) of various TV shows and/or movies.

It will be recognized that there may be circumstances in which multiple members of the same household may choose to consume media content together. In such instances, one profile will be chosen and used to view the selected media content. As a result, the watch history of the user whose profile is used to view the content will include the collectively selected content, which the user may not choose to view on his or her own or even particularly enjoy. Over time, if the same user's profile is continually used (as is often the case in multi-member households), the watch history and therefore recommendations for that user will be even more skewed and less curated particularly for that user. This is especially problematic for families, where parents watching children's content on their profile often leads to an influx of kids' recommendations they do not want. This situation also creates confusion when a person whose profile was not used to watch the content that the group watched to resume watching the content, as it shows up only in the “Continue Watching” section of the profile that was used for the group viewing experience.

In accordance with features of embodiments described herein, a mode referred to herein as “everyone mode” (or alternatively, “group mode”) addresses the aforementioned issues that arise in connection with using an individual user's profile to view content selected by two or more members of the same household by creating a shared profile that blends content recommendations from all participating users without affecting their individual profiles. In particular embodiments, when two or more profiles are available on a device (or on an account, if the account if cascaded to multiple devices), an everyone, or group, profile is automatically generated as an option and displayed along with individual user profiles. Thereafter, instead of selecting a single user's profile for group content viewing, users can select everyone mode, which curates content based on overlapping interests as reflected in the individual user profiles, ensuring that content recommendations appeal to all of the users viewing the content. Everyone mode thereby enables members of a household to watch content together without distorting or skewing the personal recommendations made to individual users based on their own profile. Additionally, everyone mode ensures that the watch history associated with the everyone profile remains separate from the watch histories of individual profiles, thereby preventing clutter in “Continue Watching” lists displayed for each profile (individual and everyone (or group)).

In operation, if media content is started in everyone mode, it remains within the everyone profile so that no individual user has unfinished content in their Continue Watching list that they did not intend to watch alone. Moreover, in cases in which at least one of the individual profiles is associated with a child, while parental controls may not be enforced as strictly in the everyone profile as they are in the child's individual profile, they may still considered when curating recommendations for the group. A simple on/off toggle may be provided in settings to provide users with full control over whether everyone mode appears as an option, making it an easy and flexible solution for group viewing without unnecessary complications.

As will be described in greater detail below, everyone mode proactively creates a shared viewing experience without disrupting personalization of any individual user's viewing experience. Unlike traditional profile switching, which forces users to select one profile at the expense of others, everyone mode dynamically blends preferences from multiple profiles to recommend content that suits the group. In other words, when in everyone mode, the system does not pull from a single user's profile to suggest content but instead finds common ground among all of the profiles associated with the everyone profile, thereby offering a more tailored, communal viewing experience.

Still further, everyone mode isolates group viewing sessions such that what is watched in everyone mode remains associated with the everyone profile and does not impact the curated content associated with individual user profiles. As a result, personal recommendations remain pure while the system enables shared enjoyment of content.

Additionally, instead of rigidly applying restrictions that may be associated with a child's profile, the multimedia system may consider but not be bound by those restrictions when curating content in everyone mode. As a result, families can watch something they deem appropriate for their child without being locked into a restrictive child profile's experience. At the same time, it prevents exposing the child to inappropriate content by surfacing recommendations that balance adult and child-friendly viewing.

Finally, an opt-out feature may be provided to enable users to disable everyone mode for any reason. Many user interface (UI) solutions for shared viewing require manual selection or extra steps; in contrast, everyone mode appears as a natural option alongside personal profiles, making it easy to use while still giving users the ability to turn it off if they choose to do so. This combination of automated personalization, temporary watch history isolation, and smart parental control handling makes everyone mode a frictionless solution for group watching.

### Example Multimedia System

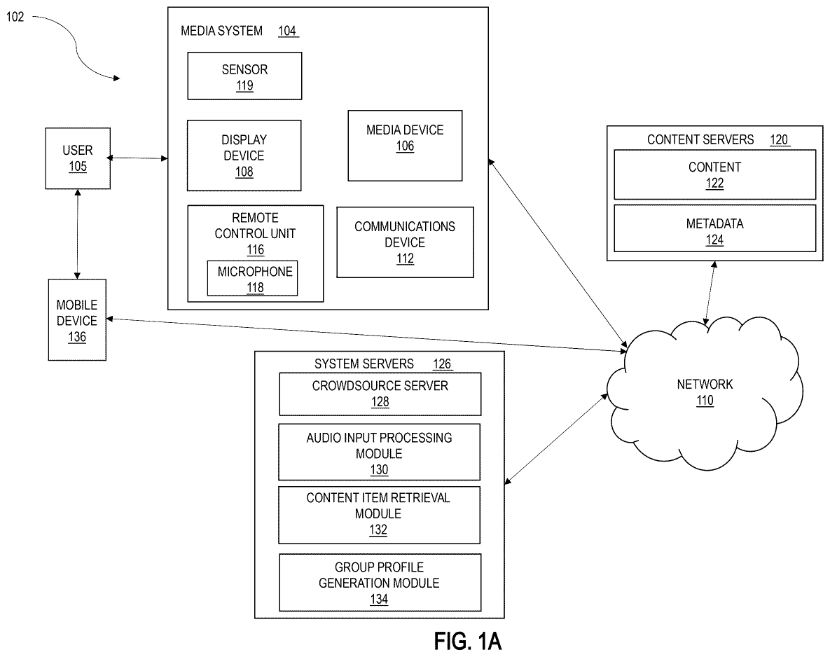

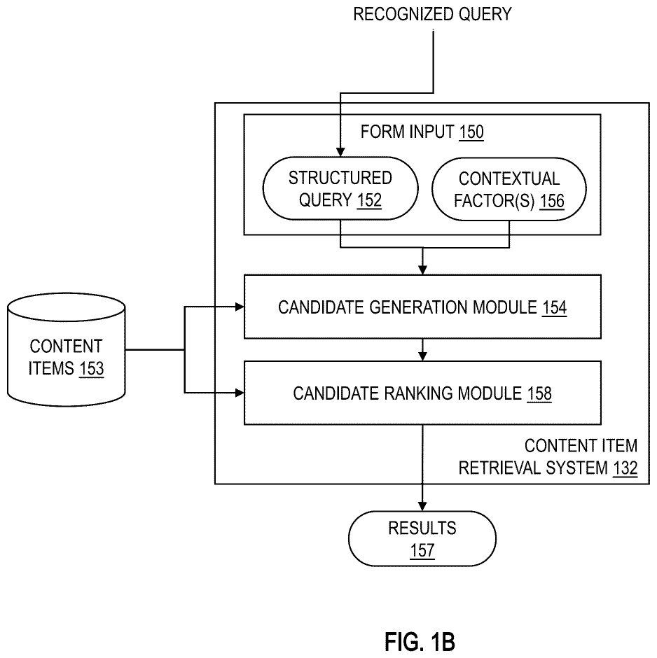

FIG. 1A illustrates a block diagram of an example multimedia system 102 according to some embodiments described herein. In a non-limiting example, multimedia system 102 may be a digital streaming media platform directed to streaming digital media content; however, embodiments described herein may be applicable to any type of media instead of or in addition to streaming media, as well as any type of mechanism, means, protocol, method, and/or process for distributing media.

Multimedia system 102 may include one or more media systems, such as media system 104. Media system 104 may represent a family room, a kitchen, a backyard, a home theater, a school classroom, a library, a car, a boat, a bus, a plane, a stadium, a movie theater, an auditorium, a bar, a restaurant, an extended reality (XR) space, and/or any other location or space where it may be desirable to receive, interact with, and/or play streaming content. Users, such as a user 105, may interact with multimedia system 102 comprising media system 104 as described herein to select, view, interact with, and/or otherwise consume content. In particular embodiments, user 105 represents multiple users comprising a household of users that may interact with multimedia system 102. One or more of users represented by user 105 may have a user profile associated with multimedia system 102.

Each media system 104 may include one or more media devices, such as media device 106, each of which may be coupled to one or more display devices, such as display device 108 (which may be implemented as an A/V device). It will be noted that terms such as “coupled,” “connected,” “attached,” “linked,” “combined,” as well as similar terms, may refer to physical, electrical, magnetic, local, and/or other types of connections, unless otherwise specified herein.

Media device 106 may include a streaming media device, DVD or BLU-RAY device, audio/video playback device, cable box, an XR device (which may include one or more of a VR device, an AR device, and an MR device), and/or digital video recording device, for example. Media device 106 may enable content from multiple content provider platforms and/or content channels to be displayed. In particular embodiments, media device 106 may be associated with a proprietary streaming service platform or multimedia delivery system. It will be noted that for the sake of simplicity, embodiments will be described with reference to a streaming service platform, but that any reference to streaming service platform herein similarly applies to a multimedia delivery system. Accordingly, as used herein, the phrase streaming service platform shall be deemed to encompass a media delivery system.

Display device 108 may include a monitor, a television, a computer, a smart phone, a tablet, a wearable (e.g., a watch, glasses, goggles and/or an XR headset), an appliance, an Internet of things (IOT) device, and/or a projector, for example. In some embodiments, media device 106 may be a part of, integrated with, operatively coupled to, and/or connected to one or more respective display devices, such as display device 108.

Media device 106 may be configured to communicate with network 110 via a communications device 112. Communications device 112 may include, for example, a cable modem or satellite TV transceiver. Media device 106 may communicate with the communications device 112 over a link that may include wireless (e.g., Wi-Fi) and/or wired connections.

In various embodiments, network 110 may include, without limitation, wired and/or wireless intranet, extranet Internet, cellular, Bluetooth, infrared, and/or any other short range, long range, local, regional, and/or global communications mechanism, means, approach, protocol, and/or network, as well as any combinations thereof.

Media system 104 may include a remote control device 116. Remote control device may include and/or be incorporated into any component, part, apparatus, and/or method for controlling media device 106 and/or display device 108, such as a remote control, a tablet, a laptop computer, a smartphone, a wearable, on-screen controls, integrated control buttons, audio controls, XR equipment, and/or any combination thereof, for example, In one embodiment, remote control device 116 wirelessly communicates with media device 106 and/or display device 108 using any wireless communications protocol. Remote control device 116 may include a microphone 118. Media system 104 may also include one or more sensors, such as sensor 119, which may be deployed for tracking movement of user 105, such as in connection with XR applications. In particular embodiments, sensor 119 may include one or more of a gyroscope, a motion sensor, a camera, an IMU, and a biometric sensor, for example. Sensor 119 may also include one or more sensing devices for sensing biometric characteristics associated with sympathetic arousal, including one or more of heart rate variability (HRV), electrodermal activity (EDA), pupil opening, and/or ocular movement. In some embodiments, sensors, such as sensor 119, may be incorporated into a device to be worn by users, such as a headset or vest. In particular embodiments, sensor 119 may comprise any sort of XR device. In still other embodiments, sensor 119 may include one or more sensors for performing sensor-based detection (e.g., voice, camera, mm Wave, biometric, etc.) to identify the individual users that are currently viewing content via multimedia system 102.

Multimedia system 102 may include a plurality of content servers 120, which may also be referred to as content providers or sources. Although only one content server 120 is shown in FIG. 1A, multimedia system 102 may include any number of content servers 120, each of which may be configured to communicate with network 110. Content servers 120 may be managed by one or more content providers, including the proprietary streaming service platform with which media device 106 is associated, as well as third party (3P) streaming service platforms. It will be noted that proprietary streaming service platform may have agreements with 3P streaming service platforms regarding provision of content and use of data owned by 3P streaming service platforms restricting the use thereof by the former. Each content server 120 may store content 122 and metadata 124. Content 122 may include media content, such as audio content, video content, image content, XR (e.g., VR, AR, and/or MR) content, gaming application content, advertising content, software content, and/or any other content or data objects in electronic form. Features or attributes of content 122 may include but are not limited to popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, and amount of advertising, for example.

In particular embodiments, metadata 124 may include data about content 122. For example, metadata 124 may include but is not limited to such information pertaining or relating to content 122 as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, scene and video understanding, and emotional understanding of the scene based on visual and dialogue cues, for example. Metadata 124 may additionally or alternatively include links to any such information pertaining to or relating to content 122. Metadata 124 may additionally or alternatively include one or more indices of content 122.m Multimedia system 102 may include one or more system servers 126, which operate to support media device 106 from the cloud. In particular embodiments, structural and functional aspects of system servers 126 may wholly or partially exist in the same or different ones of system servers 126. One or more system servers 126 may be associated with the proprietary streaming services platform with which media device 106 is associated.

Media devices, such as media device 106, may exist in numerous media systems, such as media system 104. Accordingly, media device 106 may lend itself to crowd sourcing embodiments and system servers 126 may include one or more crowdsource servers 128. System servers 126 may also include an audio input processing module 130. As noted above, remote control device 116 may include a microphone 118, which may receive audio data from user 105 as well as from other sources, such as display device 108. In some embodiments, media device 106 may be audio responsive and the audio data may represent verbal commands from user 105 to control media device 106 as well as other components in media system 104, such as display device 108.

In some embodiments audio data received by microphone 118 is transferred to media device 106, which is then forwarded to audio input processing module 130. The audio input processing module 130 may operate to process and analyze the received audio data, using automatic speech recognition, natural language understanding, and/or other speech processing techniques to recognize a verbal command and/or query from user 105. Audio input processing module 130 may forward recognized verbal commands to media device 106 for processing. Audio input processing module 130 may forward recognized verbal queries to a content item retrieval system 132 for processing. In some embodiments, audio data may be additionally or alternatively processed and analyzed by an audio command processing module in media device 106 and system servers 126 may cooperate to select one of the verbal commands to process. A group profile generation module 134 is provided for generating and managing group profiles as will be described in greater detail hereinbelow.

In particular embodiments, a mobile device 136 may be included in multimedia system 102 and may have installed thereon a mobile app associated with the proprietary streaming services platform for enabling user 105 to interact with and/or control aspects of multimedia system 102, and particularly media device 106, via a user interface (UI) displayed on a display of mobile device 136. In some embodiments, mobile device 136 may incorporate, duplicate, and/or replace some or all features and/or functions of remote control unit 116. In some embodiments, mobile app of mobile device 136 may enable User 105 to perform a variety of functions, which may include but are not limited to:
searching for content using voice or typed search commands;
viewing streamed content on the display of the mobile device;
casting media files to display device;
adding and/or launching streaming services and/or channels on the media device; and
entering text commands to multimedia system (e.g., media device) using the keyboard of the mobile device.

### Example Content Item Retrieval System

FIG. 1B illustrates a content item retrieval system such as may be implemented in the multimedia system of FIG. 1A, according to some embodiments of the disclosure. In some embodiments, recognized query from audio input processing module 130 can be provided to content item retrieval system 132, e.g., when the recognized query intent corresponds to content item retrieval. Content item retrieval system 132 may include form input 150 to create structured query 152 for retrieving relevant content items based on recognized query. Structured query 152 may include a string or a data structure expressing a search request or search parameters which can be used by candidate generation module 154 to find content items in content items 153, which may form part of content 122 (FIG. 1A). Structured query 152 may include one or more predefined fields and one or more operators arranged according to specific syntax rules. Structured query 152 may specify one or more desired search criteria, and the search criteria may be determined by form input 150 based on the recognized query. In some cases, form input 150 may retrieve or determine one or more contextual factors 156, which may be used in retrieving content items which are relevant to one or more contextual factors 156.

Examples of contextual factors 170 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, what the user has watched, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, characteristic(s) about the device the user is using to input the natural language query, the amount of bandwidth the user has on a network to receive content, the user's position in a social graph/network, the user's relationships with other users in a social graph/network, etc. It will be recognized that one or more contextual factors may be gleaned from a user profile of the user 105.

The input formed by form input 150 having structured query 152 and optionally one or more contextual factors 156 may capture context of a particular search session with a user. The input formed by form input 150 may capture information that may be helpful for understanding what a user is looking for and/or what may be relevant or useful to the user. In some cases, form input 150 may transform structured query 152 and optionally one or more contextual factors 156 into a feature vector to represent information in structured query 152 and optionally one or more contextual factors 156 in a (latent) feature space.

Content item retrieval system 132 may include several operations to produce results 157. Content item retrieval system 132 may include one or more of: candidate generation module 154, and candidate ranking module 158. Candidate generation module 154 may search in content items 153 to determine relevant candidates to structured query 152 and optionally one or more contextual factors 156. The structured query 152 and optionally one or more contextual factors 156 (or the feature vector generated therefrom) may be provided to candidate generation module 154 to find semantically and/or contextually relevant candidates, e.g., content items in content items 153 that are semantically and/or contextually relevant to structured query 152 and optionally one or more contextual factors 156. Candidate generation module 154 may use one or more models to identify a set of relevant candidates, e.g., content items relevant to structured query 152 and optionally one or more contextual factors 156. Examples of models may include keyword matching, vector space model, probabilistic model, etc. One or more models may be used to score the candidates in content items 153 and determine relevance scores. Top K highest relevance scoring candidates may be returned as the set of relevant candidates. Relevant candidates may be provided to candidate ranking module 158 for ranking.

Candidate ranking module 158 may rank the set of relevant candidates produced by candidate generation module 154. Candidate ranking module 158 may determine and output ranked candidates. Candidate ranking module 158 may determine a ranking score for each relevant candidate found by candidate generation module 154 and sort the relevant candidates based on the ranking scores to produce ranked relevant candidates. In some cases, candidate ranking module 158 may rank content items based on structured query 152 and optionally one or more contextual factors 156 (or the feature vector generated therefrom). Information based on structured query 152 and optionally one or more contextual factors 156 may be provided to candidate ranking module 158 to augment ranking of relevant candidates, e.g., content items relevant to structured query 102 and optionally one or more contextual factors 170.

Content item retrieval system 132 may return results 157 having ranked relevant candidates, e.g., content items relevant to structured query 152 and optionally one or more contextual factors 156. Results 157 may be returned to user 105. Results157 may be output (e.g., rendered for display) to user 105. Results 157 may be output to user 105 according to the ranking determined in candidate ranking module 158. In some cases, results 157 may be accentuated (e.g., enlarged) based on signaling from in candidate ranking module 158.

### Example Media Device for Multimedia System

FIG. 2 illustrates a block diagram of an example media device 106 according to some embodiments. Media device 106 may include a streaming module 202, processing module 204, a user interface module 206, and storage/buffers 208. As noted above, user interface module 206 may include an audio command processing module 210 which may perform functions similar to the audio input processing module 130 (FIG. 1A).

As shown in FIG. 2, media device 106 may also include one or more audio decoders 212 and one or more video decoders 214. Each audio decoder 212 may be configured to decode one or more audio formats, including but not limited to AAC, HE-AAC, AD3 (Dolby Digital), EAC3 (Dolby Digital Plus), WMA, WAV, PCM, MP3, OGG GSM, FLAC, AU, AIFF, and/or VOX, for example. Similarly, each video decoder 214 may be configured to decode video of one or more video formats, including but not limited to MP4 (e.g., mp4, m4a, m4v, f4v, f4a, m4b, m4r, f4b, mov), 3GP (e.g., 3gp, 3gp2, 3g2, 3gpp, 3gpp2), OGG (e.g., ogg, oga, ogv, ogx), WMV (e.g., wmv, wma, asf), WEBM, FLV, AVI, QuickTime, HDV, MXF, MPEG-TS, MPEG-2 PS, MPEG-2 TS, WAV, Broadcast WAV, LXF, GXF, and/or VOB, for example. Each video decoder 214 may include one or more video codecs, such as H.263, H.264, H.265, HEV, MPEG1, MPEG2, MPEG-TS, MPEG-4, Theora, 3GP, DV, DVCPRO, DVCProHD, IMX, XDCAM HD, XDCAM HD422, AND XDCAM EX, for example.

Referring now to FIGS. 1A, 1B, and 2, in some embodiments, user 105 may interact with media device 106 via, for example, remote control device 116. For example, user 105 may use remote control device 116 to interact with user interface module 206 of the media device 106 to select content, such as a movie, TV show, music, book, application, game, etc. The streaming module 202 of media device 106 may request the selected content from content servers 120 over network 110. Content servers 120 may transmit the requested content to the streaming module 202. Media device 106 may transmit the received content to the display device 108 for playback to user 105.

In streaming embodiments, streaming module 202 may transmit content to display device 108 in real time or near real time as it receives such content from content servers 120. In non-streaming embodiments, media device 106 may store content received from content servers 120 in storage/buffers 208 for later playback on display device 108, for example.

### Example Operations for Creating and Using Group Profiles

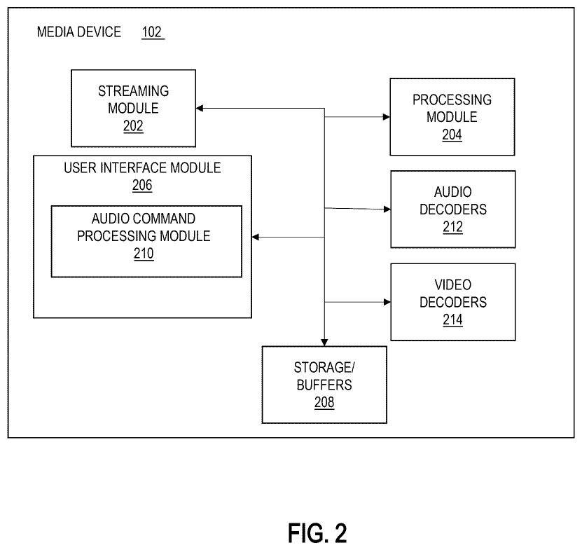

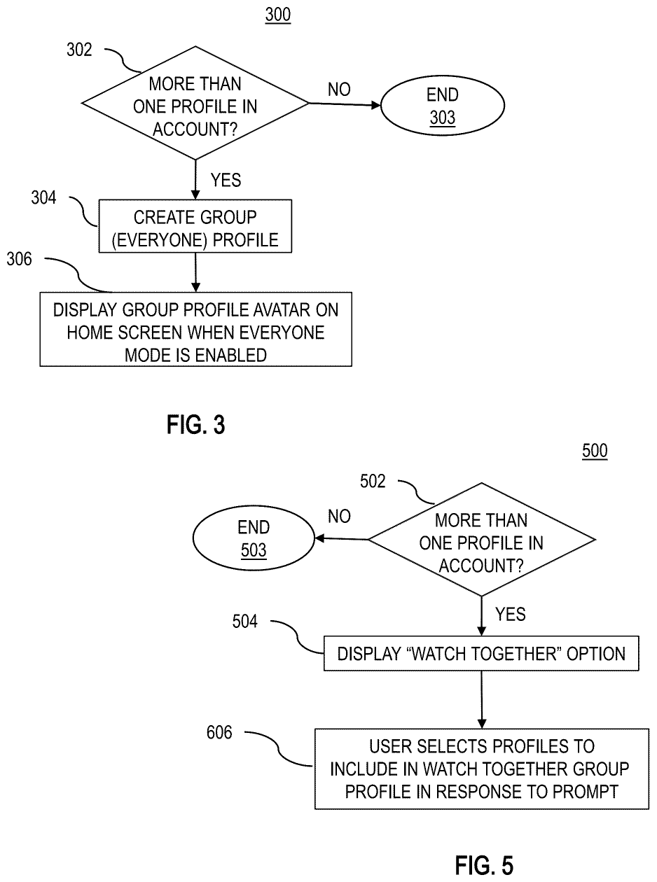

FIG. 3 is a flow diagram 300 of example operations that may be performed in a multimedia system to create a group profile, according to some embodiments of the disclosure in which a group profile is automatically created. In certain embodiments, one or more of the operations illustrated in FIG. 3 may be performed by one or more of the elements illustrated in FIGS. 1A, 1B, and/or 2, for example (e.g., group profile creation module 134).

In operation 302, a determination is made whether there is more than one profile in the account. If a negative determination is made in operation 302, execution terminates in operation 303. In particular embodiments, operation 302 is implemented whenever a profile is added or removed.

If a positive determination is made in operation 302, execution proceeds to operation 304, in which a group (or everyone) profile is automatically created.

In operation 306, an avatar for the group profile is displayed on the home screen when everyone mode is enabled.

Although the operations of the example method shown in and described with reference to FIG. 3 are illustrated as occurring once each and in a particular order, it will be recognized that the operations may be performed in any suitable order and repeated as desired. Additionally, one or more operations may be performed in parallel. Furthermore, the operations illustrated in FIG. 3 may be combined or may include more or fewer details than described.

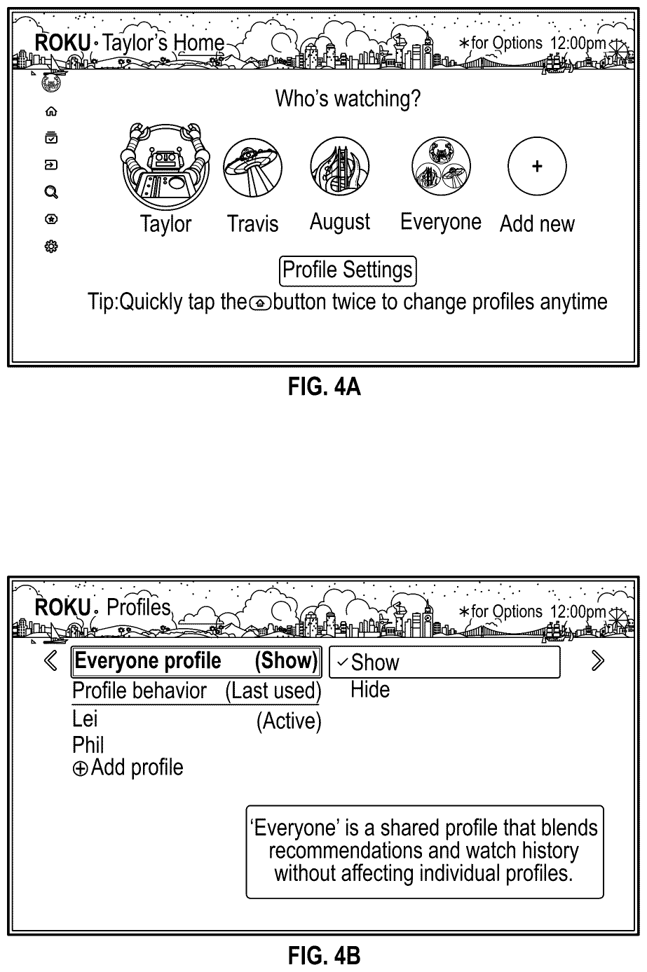

Referring now to FIG. 4A, illustrated therein is an example home page for an account showing avatars individual profiles for users Taylor, Travis, and August and an Everyone avatar (or collection of avatars comprising the individual avatars for users Taylor, Travis, and August) for the automatically created Everyone profile.

FIG. 4B illustrates an example display for enabling and disabling the everyone mode. In particular, with the Everyone profile is selected, selecting “Show” will result in the Everyone profile avatar being displayed on the home page (as illustrated in FIG. 4A), while 132

In particular embodiments, the group profile created as shown in FIGS. 3 and 4A-4B does not have independent settings. Content preferences and watch histories from all of the individual profiles in the account (in the illustrated example, Taylor, Travis, and August) are factored into content recommendation. Additionally, watch history for the group profile is not applied to any individual profile, but it may be captured and related to the group profile and maintained across viewing sessions.

In some embodiments, parental control settings that may be applicable to any of the individual profiles are not applied to the group profile and other means of preventing a child from accessing and using the group profile may be applied. In alternative embodiments, selective enabling and/or disabling of application of parental control settings that are applicable to any of the individual profiles to the group profile may be controlled via a toggle switch, similar to the selective enabling/disabling of everyone mode.

In some embodiments, device-specific setting (theme, language, app ordering, etc.) may utilize the settings of the account owner (i.e., the first profile). In some embodiments, all apps on the system will be displayed for the group profile, with no filtering or hiding of apps being implemented.

In an alternative embodiment, the multimedia system may be able to discern who is actually watching at a given time and generate a group profile that includes the individual profiles of only those users who are watching. In this embodiment, the system could generate a unique group profile for the subset of users currently watching and the system (e.g., content item retrieval system) would pull from only the individual profiles of that subset of users. It is anticipated that in this embodiment, there would be multiple group profiles, which could be static (e.g., such that the Continue Watching list could be available) or dynamically created (e.g., if only content item recommendations are desired based on the individual profiles of the subset of users).

FIG. 5 is a flow diagram 500 of example operations that may be performed in a multimedia system to create a group profile, according to alternative embodiments of the disclosure referred to herein as “Watch Together.” In certain embodiments, one or more of the operations illustrated in FIG. 5 may be performed by one or more of the elements illustrated in FIGS. 1A, 1B, and/or 2, for example (e.g., group profile creation module 134).

In operation 502, a determination is made whether there is more than one profile in the account. If a negative determination is made in operation 502, execution terminates in operation 503. In particular embodiments, operation 502 is executed whenever a profile is added or removed.

If a positive determination is made in operation 502, execution proceeds to operation 504, in which a Watch Together option is displayed on the home screen.

In operation 506, a user selects individual user profiles to include in the Watch Together group profile in response to the prompt.

Although the operations of the example method shown in and described with reference to FIG. 5 are illustrated as occurring once each and in a particular order, it will be recognized that the operations may be performed in any suitable order and repeated as desired. Additionally, one or more operations may be performed in parallel. Furthermore, the operations illustrated in FIG. 5 may be combined or may include more or fewer details than described.

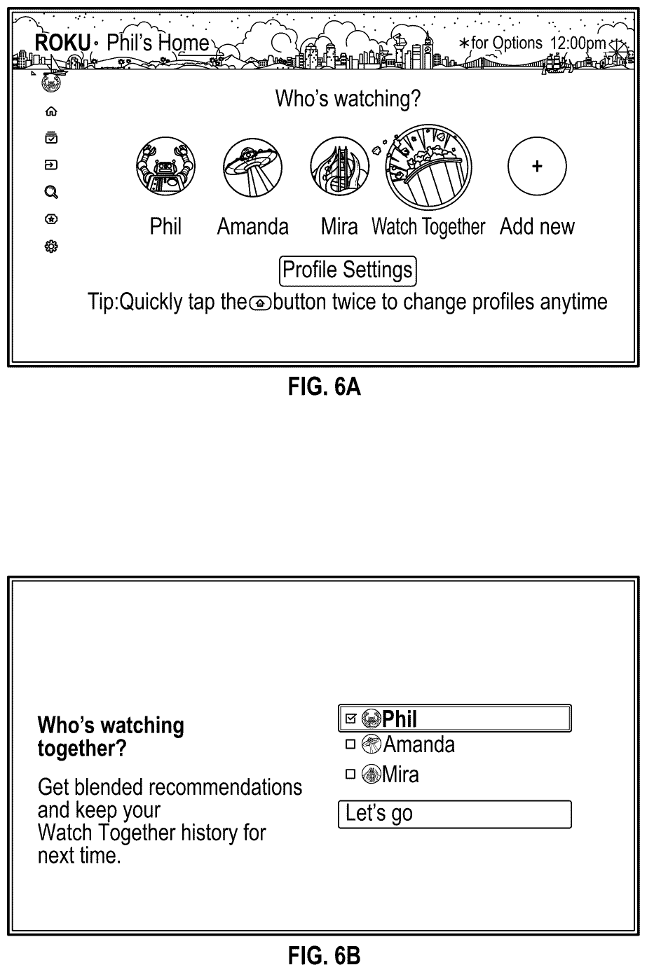

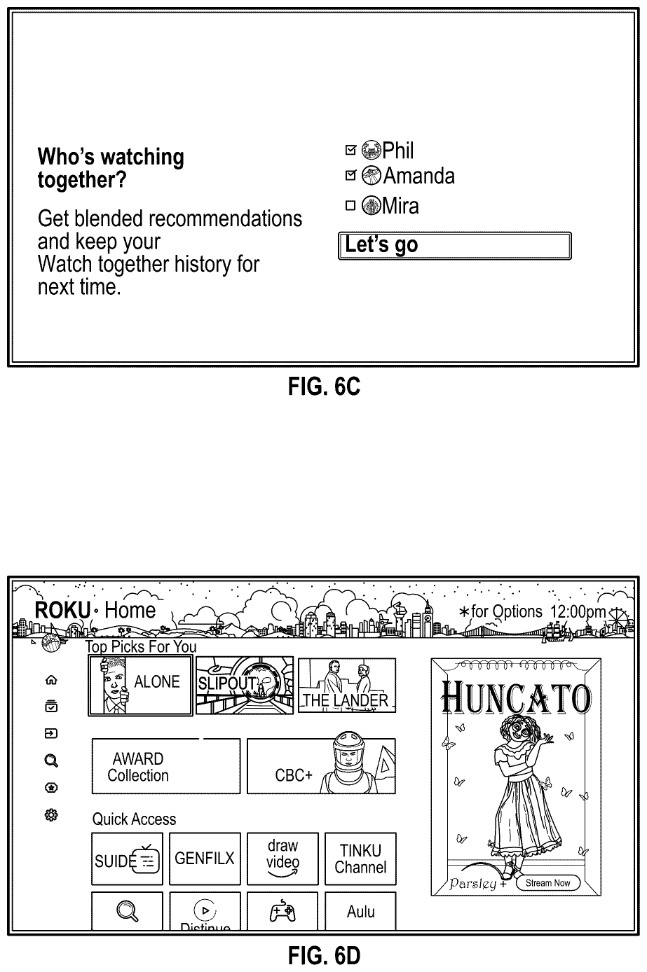

Referring now to FIG. 6A, illustrated therein is an example home page for an account showing avatars individual profiles for users Phil, Amanda, and Mira and a Watch Together avatar for group profile. To select individual user profiles to include in the Watch Together profile, the user clicks on the Profile Settings button while the Watch Together profile is highlighted, resulting in display of the screen shown in FIG. 6B.

FIG. 6B illustrates a display for enabling a user to select individual users to include in the Watch Together group profile. In the illustrated example, all users with profiles under the account are listed on the screen with a checkbox next to their name for selecting/deselecting the individual user. Users to be included in the Watch Together group are selected by checking the box next to their name and then clicking the Let's Go button once all of the users to be included have been selected, as shown in FIG. 6C. FIG. 6D illustrates the home screen of the Watch Together profile that includes recommendations based on the profiles of the individual users selected to be included in the Watch Together group.

In particular embodiments, the group profile created as shown in FIGS. 5 and 6A-6E does not have independent settings. Content preferences and watch histories from all of the individual profiles in the account (in the illustrated example, Phil, Amanda, and Mira) are factored into content recommendation. Additionally, watch history for the group profile is not applied to any individual profile, but it may be captured and related to the group profile and maintained across viewing sessions.

In some embodiments, parental control settings that may be applicable to any of the individual profiles are not applied to the group profile and other means of preventing a child from accessing and using the group profile may be applied. In alternative embodiments, selective enabling and/or disabling of application of parental control settings that are applicable to any of the individual profiles to the group profile may be controlled via a toggle switch, similar to the selective enabling/disabling of everyone mode.

In some embodiments, device-specific setting (theme, language, app ordering, etc.) may utilize the settings of the account owner (i.e., the first profile). In some embodiments, all apps on the system will be displayed for the group profile, with no filtering or hiding of apps being implemented.

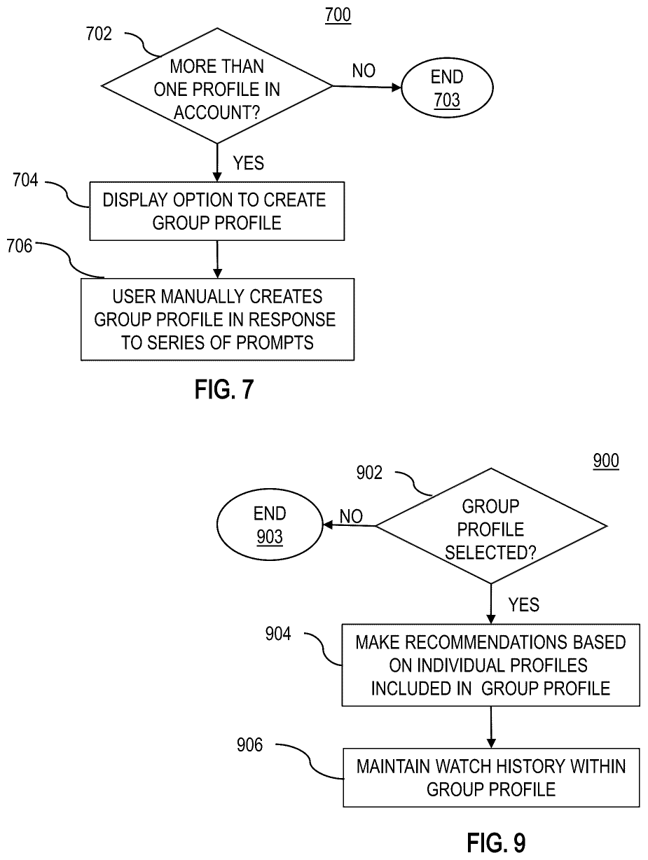

FIG. 7 is a flow diagram 700 of example operations that may be performed in a multimedia system to create a group profile, according to other alternative embodiments of the disclosure. In certain embodiments, one or more of the operations illustrated in FIG. 7 may be performed by one or more of the elements illustrated in FIGS. 1A, 1B, and/or 2, for example (e.g., group profile creation module 134).

In operation 702, a determination is made whether there is more than one profile in the account. If a negative determination is made in operation 702, execution terminates in operation 703. In particular embodiments, operation 702 is performed whenever a profile is added or removed.

If a positive determination is made in operation 702, execution proceeds to operation 704, in which an option to manually create a group profile is presented on the home screen.

In operation 706, a user manually creates a group profile in response to a series of prompts presented on the display.

Although the operations of the example method shown in and described with reference to FIG. 7 are illustrated as occurring once each and in a particular order, it will be recognized that the operations may be performed in any suitable order and repeated as desired. Additionally, one or more operations may be performed in parallel. Furthermore, the operations illustrated in FIG. 7 may be combined or may include more or fewer details than described.

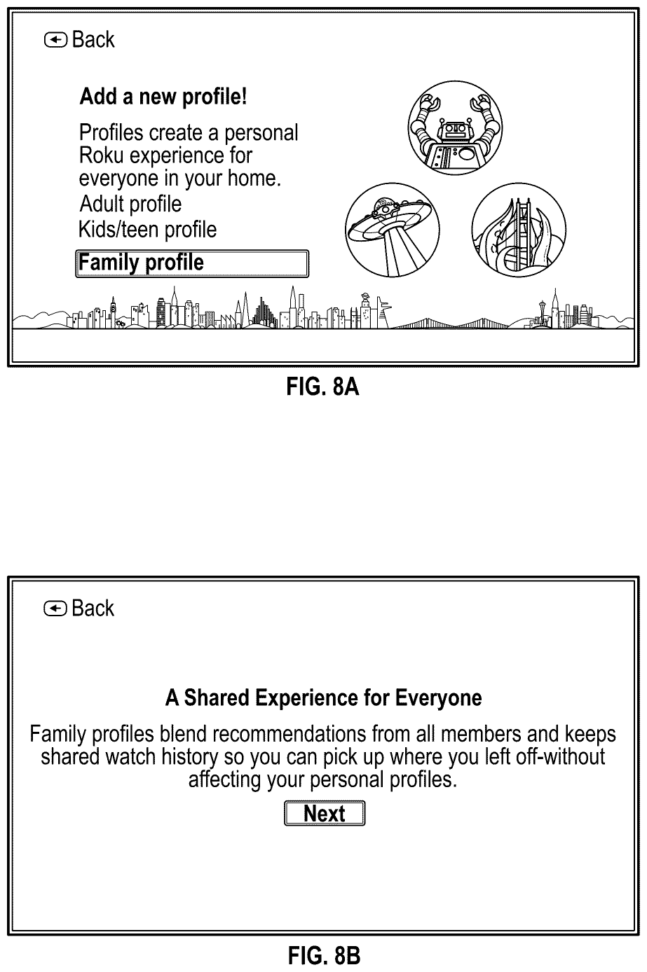

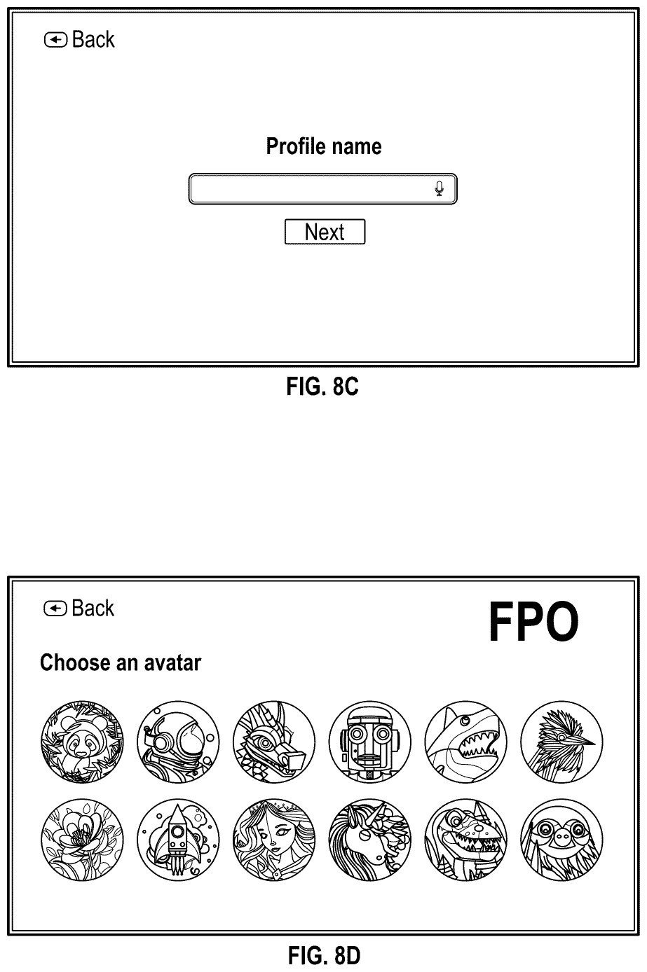

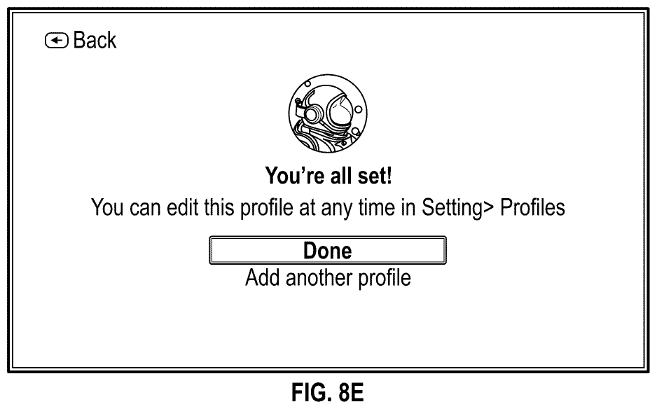

Referring now to FIG. 8A, illustrated therein is an example screen for enabling a user to manually add a group profile (in the illustrated embodiment referred to as a “family profile”). Once the user selects the Family Profile option, FIG. 8B may be displayed to explain the purpose of family profiles in the system.

FIGS. 8C and 8D illustrate example screens prompting the user to enter a name for and select an avatar to represent the group profile. FIG. 8E illustrates an example screen confirming setup of the group profile and prompting the user to either complete the process or add another group profile. The avatar representing the newly created group profile will be displayed on the home screen with the avatars for the individual profiles (e.g., as shown in FIGS. 4A and 6A). The manually created group profile, like the automatically created group profile (FIGS. 3 and 4A-4B) will, by default, include all of the individual users/profiles on the account.

In particular embodiments, the group profile created as shown in FIGS. 7 and 8A-8E (and unlike the group profiles created as shown in FIGS. 3-6D) does have independent settings. Content preferences and watch histories from all of the individual profiles in the account (in the illustrated example, Phil, Amanda, and Mira) are factored into content recommendation. Additionally, watch history for the group profile is not applied to any individual profile, but it may be captured and related to the group profile and maintained across viewing sessions.

In some embodiments, parental control settings that may be applicable to any of the individual profiles are not applied to the group profile and other means of preventing a child from accessing and using the group profile may be applied. In alternative embodiments, selective enabling and/or disabling of application of parental control settings that are applicable to any of the individual profiles to the group profile may be controlled via a toggle switch, similar to the selective enabling/disabling of everyone mode.

In some embodiments, device-specific setting (theme, language, app ordering, etc.) may utilize the settings of the account owner (i.e., the first profile). In some embodiments, all apps on the system will be displayed for the group profile, with no filtering or hiding of apps being implemented.

FIG. 9 is a flow diagram 900 of example operations that may be performed in a multimedia system when a group profile is selected, according to some embodiments of the disclosure. In certain embodiments, one or more of the operations illustrated in FIG. 9 may be performed by one or more of the elements illustrated in FIGS. 1A, 1B, and/or 2, for example.

In operation 902, a determination is made whether there is more than one profile in the account. If a negative determination is made in operation 902, execution terminates in operation 903 and recommendations are made based on the single existing profile.

If a positive determination is made in operation 902, execution proceeds to operation 904, in which the system (e.g., content item retrieval system 132) makes recommendations based on the individual profiles included in the group profile collectively.

In operation 906, the system maintains watch history for the group profile independently of the individual user profiles.

Although the operations of the example method shown in and described with reference to FIG. 9 are illustrated as occurring once each and in a particular order, it will be recognized that the operations may be performed in any suitable order and repeated as desired. Additionally, one or more operations may be performed in parallel. Furthermore, the operations illustrated in FIG. 9 may be combined or may include more or fewer details than described.

As described herein, everyone mode makes group content viewing effortless while keeping personal recommendations intact. Unlike known alternatives, where shared viewing skews individual profiles, everyone mode intelligently blends preferences from multiple users, surfacing content everyone will enjoy without affecting each user's personal watch history. Everyone mode also provides smart parental control flexibility, allowing families to enjoy age-appropriate content without restrictive child-profile limitations.

Additional alternatives to embodiments described herein may include embodiments in which users are allowed to manually select multiple profiles when starting a session, instead of generating a static everyone profile automatically and AI-based adaptive recommendations without creating a separate group profile.

Still further alternatives to embodiments described herein may include embodiments in which sensors (e.g., sensor 119 (FIG. 1)) perform sensor-based detection (e.g., voice, camera, mmWave, biometric, etc.) to identify the individual users comprising a group of users viewing content during a particular session and creating a group profile for that group of users. In this embodiment, multiple group profiles may be created, deployed, and maintained across sessions in the manners described above.

### Example Computing Device

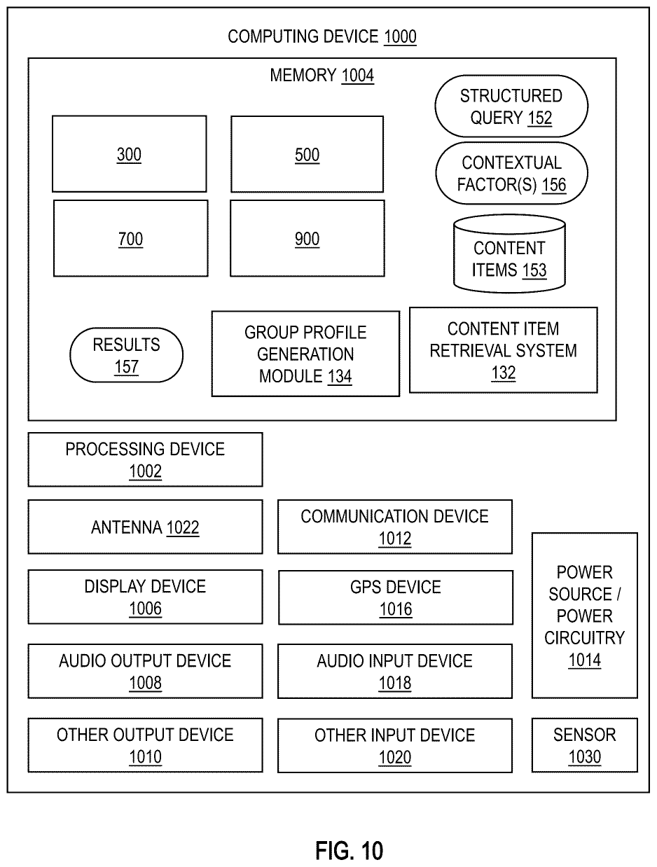

FIG. 10 is a block diagram of an exemplary computing device 1000, according to some embodiments of the disclosure. One or more computing devices 1000 may be used to implement the functionalities described with the FIGUREs and herein. A number of components are illustrated in the FIGUREs as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002.

In some embodiments, memory 1004 includes one or more non-transitory computer-readable media storing instructions executable to perform operations described with the FIGUREs and herein, such as the methods illustrated in FIGS. 1-9, including methods 300, 500, 700, and 900.

Memory 1004 may store instructions that encode one or more exemplary parts. Exemplary parts that may be encoded as instructions and stored in memory 1004 are depicted. Exemplary parts may include one or more components of content item retrieval system 132 of FIG. 1. Exemplary parts may include one or more components of group profile generation module 34 of FIG. 1. The instructions stored in the one or more non-transitory computer-readable media may be executed by processing device 1002.

In some embodiments, memory 1004 may store data, e.g., data structures, binary data, bits, metadata, files, blobs, etc., as described with the FIGUREs and herein. Exemplary data that may be stored in memory 1004 are depicted. Exemplary data may include structured query 152, content items 153, one or more contextual factors 156, and results 157.

In some embodiments, memory 1004 may store one or more machine learning models (and or parts thereof) that are used in one or more of content item retrieval system 132 and group profile generation module 134, illustrated in FIG. 1 and other FIGUREs. The machine learning models may include large language models described herein. Memory 1004 may store training data for training the one or more machine learning models. Memory 1004 may store input data (e.g., input tokens), output data (e.g., output tokens), intermediate outputs, intermediate inputs of one or more machine learning models. Memory 1004 may store instructions to perform one or more operations of the machine learning model. Memory 1004 may store one or more parameters used by the machine learning model. Memory 1004 may store information that encodes how processing units of the machine learning model are connected with each other.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1000 may be any other electronic device that processes data.

### Select Examples

Example 1 provides a computer-implemented method including automatically creating a group profile for an account associated with a streaming service platform, in which the group profile is informed by a plurality of individual user profiles associated with the account, in which the individual user profiles are associated different ones of the plurality of users; presenting via a user interface (UI) of the streaming service platform representations of each of the group profile and the individual user profiles; prompting one of the users to select one of the profiles to use to view content items via the streaming service platform; and subsequent to selection by the user of the group profile, presenting via the UI a collection of content item recommendations, in which the content item recommendations are informed by contents of the individual user profiles collectively.

Example 2 provides the computer-implemented method of example 1, in which the automatically creating the group profile includes using at least one sensor to identify a subset of the plurality of users currently viewing content, in which the group profile is informed by a subset of the individual user profiles associated with the subset of the plurality of users.

Example 3 provides the computer-implemented method of example 1 or 2, further including maintaining for the group profile a list of content items viewed by the users using the group profile.

Example 4 provides the computer-implemented method of example 3, in which the list of content items viewed by the users using the group profile is not maintained in connection with the individual user profiles of the users.

Example 5 provides the computer-implemented method of any one of examples 1-4, further including maintaining in connection with the group profile a currently watching list including a list of content items the users have started and not finished viewing using the group profile.

Example 6 provides the computer-implemented method of example 5, in which the currently watching list is not maintained in connection with the individual user profiles of the users.

Example 7 provides the computer-implemented method of example 5 or 6, further including subsequent to selection of the group profile, presenting via the UI a representation of the currently watching list.

Example 8 provides the computer-implemented method of any one of examples 1-7, in which the automatically creating is only performed if one of the users has enabled an everyone mode in connection with the account.

Example 9 provides the computer-implemented method of any one of examples 1-8, in which viewing restrictions associated with at least one of the individual accounts are not used to filter the group profile content item recommendations.

Example 10 provides a computer-implemented method including presenting via a user interface (UI) of a streaming service platform a prompt to create a group profile for an account having associated therewith a plurality of individual user profiles, in which each of the individual user profiles is associated with a different one of a plurality of users, the prompt including prompting one of the users to select a subset of the individual profiles to associated with the group profile; presenting via the UI representations of each of the group profile and the individual profiles, in which the users may select one of the profiles to use to view content items via the streaming service platform; and subsequent to selection of the group profile, presenting via the UI a collection of content item recommendations, in which the content item recommendations are informed by contents of the selected subset of individual user profiles collectively.

Example 11 provides the computer-implemented method of example 10, further including maintaining for the group profile a list of content items viewed by the users using the group profile.

Example 12 provides the computer-implemented method of example 11, in which the list of content items viewed by the users using the group profile is not maintained in connection with the individual user profiles of the users.

Example 13 provides the computer-implemented method of any one of examples 10-12, further including maintaining in connection with the group profile a currently watching list including a list of content items the users have started and not finished viewing using the group profile.

Example 14 provides the computer-implemented method of example 13, in which the currently watching list is not maintained in connection with the individual user profiles of the users.

Example 15 provides the computer-implemented method of example 13 or 14, further including subsequent to selection of the group profile, presenting via the UI a representation of the currently watching list.

Example 16 provides the computer-implemented method of any one of examples 10-15, in which the automatically creating is only performed if one of the users has enabled an everyone mode in connection with the account.

Example 17 provides the computer-implemented method of any one of examples 10-16, in which viewing restrictions associated with at least one of the selected subset of individual user profiles are not used to filter the group profile content item recommendations.

Example 18 provides the computer-implemented method of any one of examples 10-17, in which the prompt further includes prompting the one of the users to an avatar including the representation for the group profile.

Example 19 provides one or more non-transitory computer-readable media storing instructions that, when executed by one or more processors, cause the one or more processors to: present via a user interface (UI) of a streaming service platform a series of prompts to create a group profile for an account having associated therewith a plurality of individual user profiles, in which each of the individual user profiles is associated with a different one of a plurality of users, the series of prompts including prompting entry of a name for the group profile and prompting selection of an avatar for representing the group profile; presenting via the UI representations of each of the group profile and the individual profiles, in which the users may select one of the profiles to use to view content items via the streaming service platform; and subsequent to selection of the group profile, presenting via the UI a collection of content item recommendations, in which the content item recommendations are informed by contents of the individual user profiles collectively.

Example 20 provides the one or more non-transitory computer-readable media of example 19, in which the instructions, when executed by the one or more processors, further cause the one or more processors to: maintain for the group profile a list of content items viewed by the users using the group profile, in which the list of content items viewed by the users using the group profile is not maintained in connection with the individual user profiles of the users; maintain in connection with the group profile a currently watching list including a list of content items the users have started and not finished viewing using the group profile, in which the currently watching list is not maintained in connection with the individual user profiles of the users; and subsequent to selection of the group profile, presenting via the UI a representation of the currently watching list.

### Variations and Other Notes

Although the operations of the example methods shown in and described with reference to the FIGUREs are illustrated as occurring once each and in a particular order, it will be recognized that the operations may be performed in any suitable order and repeated as desired. Additionally, one or more operations may be performed in parallel. Furthermore, the operations illustrated in the FIGUREs may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure considering the above detailed description.

For purposes of explanation, specific numbers, materials, and configurations are set forth to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. These operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” refer to being within +/−20% of a target value as described herein or as known in the art. Similarly, terms indicating orientation of various elements, e.g., “coplanar,” “perpendicular,” “orthogonal,” “parallel,” or any other angle between the elements, refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A computer-implemented method comprising:
determining a total number of individual profiles already associated with a streaming service platform account;
in response to determining that the total number of individual profiles is two or more, automatically creating a group profile for account wherein the group profile is informed by the individual user profiles wherein each individual user profile is associated with different ones of a plurality of users;
presenting via a user interface (UI) of the streaming service platform representations of each of the group profile and the individual user profiles;
prompting one of the users to select one of the profiles to use to view content items via the streaming service platform; and
subsequent to selection by the user of the group profile, presenting via the Ul a collection of content item recommendations, wherein the content item recommendations are informed by contents of the individual user profiles collectively.

2. (canceled)

3. The computer-implemented method of claim 1, further comprising:
maintaining for the group profile a list of content items viewed by the users using the group profile.

4. The computer-implemented method of claim 3, wherein the list of content items viewed by the users using the group profile is not maintained in connection with the individual user profiles of the users.

5. The computer-implemented method of claim 1, further comprising maintaining in connection with the group profile a currently watching list comprising a list of content items the users have started and not finished viewing using the group profile.

6. The computer-implemented method of claim 5, wherein the currently watching list is not maintained in connection with the individual user profiles of the users.

7. The computer-implemented method of claim 5, further comprising:
subsequent to selection of the group profile, presenting via the UI a representation of the currently watching list.

8. The computer-implemented method of claim 1, wherein the automatically creating is only performed if one of the users has enabled an everyone mode in connection with the account.

9. The computer-implemented method of claim 1, wherein viewing restrictions associated with at least one of the individual accounts are not used to filter the group profile content item recommendations.

10. A computer-implemented method comprising:
determining whether an everyone mode is enabled;
in response to determining that the everyone mode is enabled, automatically creating a group profile for an account associated with a streaming service platform, wherein the group profile is informed by a plurality of individual user profiles, wherein the individual user profiles are associated different ones of a plurality of users;
presenting via a user interface (UI) representations of each of the group profile and the individual profiles, wherein the users may select one of the profiles to use to view content items via the streaming service platform; and
subsequent to selection of the group profile, presenting via the UI a collection of content item recommendations, wherein the content item recommendations are informed by contents of the selected subset of individual user profiles collectively.

11. The computer-implemented method of claim 10, further comprising:
maintaining for the group profile a list of content items viewed by the users using the group profile.

12. The computer-implemented method of claim 11, wherein the list of content items viewed by the users using the group profile is not maintained in connection with the individual user profiles of the users.

13. The computer-implemented method of claim 10, further comprising maintaining in connection with the group profile a currently watching list comprising a list of content items the users have started and not finished viewing using the group profile.

14. The computer-implemented method of claim 13, wherein the currently watching list is not maintained in connection with the individual user profiles of the users.

15. The computer-implemented method of claim 13, further comprising:
subsequent to selection of the group profile, presenting via the UI a representation of the currently watching list.

16. (canceled)

17. The computer-implemented method of claim 10, wherein viewing restrictions associated with at least one of the selected subset of individual user profiles are not used to filter the group profile content item recommendations.

18. The computer-implemented method of claim 10, wherein the prompt further includes prompting the one of the users to an avatar comprising the representation for the group profile.

19. One or more non-transitory computer-readable media storing instructions that, when executed by one or more processors, cause the one or more processors to:
determine a total number of individual profiles already associated with a streaming service platform account;
in response to a determination that the total number of individual profiles is two or more, automatically create a group profile for the account, wherein the group profile is informed by the individual user profiles, wherein each individual user profile is associated with different ones of a plurality of users;
present via the UI representations of each of the group profile and the individual profiles, wherein the users may select one of the profiles to use to view content items via the streaming service platform; and subsequent to selection of the group profile, present via the Ul a collection of content item recommendations, wherein the content item recommendations are informed by contents of the individual user profiles collectively.

20. The one or more non-transitory computer-readable media of claim 19, wherein the instructions, when executed by the one or more processors, further cause the one or more processors to:
maintain for the group profile a list of content items viewed by the users using the group profile, wherein the list of content items viewed by the users using the group profile is not maintained in connection with the individual user profiles of the users;
maintain in connection with the group profile a currently watching list comprising a list of content items the users have started and not finished viewing using the group profile, wherein the currently watching list is not maintained in connection with the individual user profiles of the users; and
subsequent to selection of the group profile, presenting via the UI a representation of the currently watching list.

21. The computer-implemented method of claim 1, further comprising:
in response to determining that the number of individual profiles is less than two, presenting via the user interface the UI representations for each individual user profile without presenting the UI representation for the group profile.

22. The computer-implemented method of claim 10, further comprising:
in response to determining that everyone mode is not enabled, presenting via the user interface Ul representations for each individual user profile for the plurality of user profiles without presenting the group profile.
